(19) United States
(12) Patent Application Publication
(10) Pub. No.: US 2007/0286190 A1
(43) Pub. Date: Dec. 13, 2007

(54) Transmitter-receiver crossbar for a packet switch

(75) Inventors: Wolfgang Emil Denzel, Langnau am Albis (CH); Ronald Peter Luijten, Thalwil (CH); Thomas E. Morf, Gross (CH); Martin Leo Schmatz, Rueschlikon (CH)

Correspondence Address: Anne Vachon Dougherty, 3173 Cedar Road, Yorktown Heights, NY, 10598, US

(73) Assignee: International Business Machines Corporation, Armonk, NY (US)

(21) Appl. No.: 11/803,803

(22) Filed: May 16, 2007

(30) Foreign Application Priority Data
May 16, 2006 (EP) 06113992.9

(51) Int. Cl. H04L 12/56

(52) U.S. Cl. 370/389

(57) ABSTRACT

A transmitter-receiver crossbar for a packet switch comprising a transmitter having an array of transmitting ports, each having one or more transmitting antennas to transmit a radio signal and a receiver having an array of receiving ports, each having one or more receiving antennas to receive the radio signal.

### TECHNICAL FIELD

The present invention relates to a transmitter-receiver crossbar arrangement for a packet switch. The packet switch can be used to switch data packets for example in a multi processor computer system.

### BACKGROUND OF THE INVENTION

Packet switches are used to route data packets from n inputs to n outputs. Such switches are not only used in the telecom industry, but are also required for multi processor computer systems in order to interconnect the increasing numbers of CPU (central processing unit) nodes in modern computer systems. Traditionally packet switches have been realized electronically. Different architectures have been developed over the years.

With increasing port number and data speed the switching chips have grown to die sizes, which are at the technological maximum which can be fabricated due to yield limitations. Next generation switches will probably be distributed switches, realized as multi rack system. As a further step to pure electrical switches, optical packet switches are investigated. However, despite the many advantage of optics, most optical concepts suffer from the limited switching speed of the optical components. As a result, a true packet switch, which examines the header and immediately switches the payload of the package to the desired output, is very difficult to realize in optics due the slow switching speed of optical switches. In addition the costly electrical to optical and optical to electrical conversion is needed.

In a traditional electrical crossbar switch the incoming data stream is demultiplexed after the port due to speed limitations of the electrical switch. As a result, one needs many switches in parallel to be able to handle the high speed data. A 100 Gb/s per port switch needs a demultiplexing ratio of at least 16, which results in 16 switches in parallel, on a single or multiple chips.

### SUMMARY OF THE INVENTION

An object of the invention is to provide a transmitter-receiver crossbar for a packet switch and a method for switching-data with this transmitter-receiver crossbar which require less power and afford an improved ports scaling.

According to one aspect of the invention, the object is achieved by a transmitter-receiver crossbar for a packet switch with the features of the independent claim 1.

The transmitter-receiver crossbar for a packet switch according to the invention comprises a transmitter with an array of transmitting ports, wherein each transmitting port comprises one or more transmitting antennas to transmit a radio signal. The transmitter-receiver crossbar further comprises a receiver with an array of receiving ports, wherein each receiving port comprises one or more receiving antennas to receive the radio signal.

According to another aspect of the invention, the object is achieved by a method for switching data with the transmitter-receiver crossbar with the features of claim 12.

The method for switching data in a switch having an array of transmitting ports, wherein each transmitting port comprises one or more transmitting antennas, and an array of receiving ports, wherein each receiving port comprises one or more receiving antennas, according to the invention comprises the following steps. The data are fed to one of the transmitting ports. Then the data are beamed by means of the radio signal to the corresponding receiving port. Finally, the data are regained from the received radio signal at the corresponding receiving port.

Advantageous further developments of the invention arise from the characteristics indicated in the dependent patent claims.

Preferably, in the transmitter-receiver crossbar according to the invention the receiver is arranged opposite to the transmitter. With that, the transmission quality can be increased and the power consumption further decreased.

In an embodiment of the transmitter-receiver crossbar according to the invention the transmitting antennas of a transmitting port are arranged in lines and columns to form a phased array. With that the direction of the transmitted radio signal can be steered.

In a further embodiment of the transmitter-receiver crossbar according to the invention a control device is provided to steer the phased array so that the radio signal transmitted by the phased array can be directed to the desired receiving port.

In another embodiment of the transmitter-receiver crossbar according to the invention the receiving antennas of a receiving port are arranged in lines and columns to form a phased array. With that, the transmission quality can be further increased and the power consumption decreased.

Advantageously, the transmitter-receiver crossbar according to the invention comprises a dielectric material which is arranged between the transmitter and the receiver to increase the relative dielectric constant in the space between the transmitter and receiver.

The transmitter-receiver crossbar according to the invention can also comprise a lens which is arranged between the transmitter and the receiver.

According to an aspect of the invention, a packet switch with the above mentioned transmitter-receiver crossbar can be provided, wherein for each transmitting antenna a phase shifter is provided.

Alternatively thereto, in the packet switch according to the invention for each transmitting antenna an oscillator can be provided, wherein the oscillators of neighboring transmitting antennas are coupled by means of a coupling network.

In a preferred embodiment of the packet switch according to the invention for each receiving antenna a phase shifter is provided.

As a further improvement the packet switch according to the invention can comprise a reference oscillator for generating a carrier signal, which is connected by means of an electrical line to the transmitter and the receiver.

The packet switch according to the invention can be used to switch data packets. Finally, the packet switch according to the invention can be used to switch data in a multiprocessor system, in an internet router or any other switching application.

In the method according to the invention the data can be modulated with a reference frequency by means of a modulator and the phase of the modulated data can be shifted by means of phase shifters before the data are beamed to the corresponding receiver.

Alternatively, in the method according to the invention the data can be modulated by means of phase shifted modulation signals before the data are beamed to the corresponding receiver.

### BRIEF DESCRIPTION OF THE DRAWINGS

The invention and its embodiments will be more fully appreciated by reference to the following detailed description of presently preferred but nonetheless illustrative embodiments in accordance with the present invention when taken in conjunction with the accompanying drawings.

The figures are illustrating:

FIG. 1 a concept of a transmitter and a receiver crossbar for a high speed packet switch in a three dimensional view,

FIG. 2 a section of the transmitter and the receiver for a high speed packet switch along with control devices,

FIG. 3 a first embodiment of a transmitting stage and a receiving stage for the above mentioned transmitter and the receiver,

FIG. 4 a second embodiment of the transmitting stage for the above mentioned transmitter,

FIG. 5a the electrical connections between multiple transmitting cells in a two dimensional transmitting array, and

FIG. 5b a more detailed depiction of the design of a single transmitting cell of the two dimensional transmitting array.

### DETAILED DESCRIPTION OF THE DRAWINGS

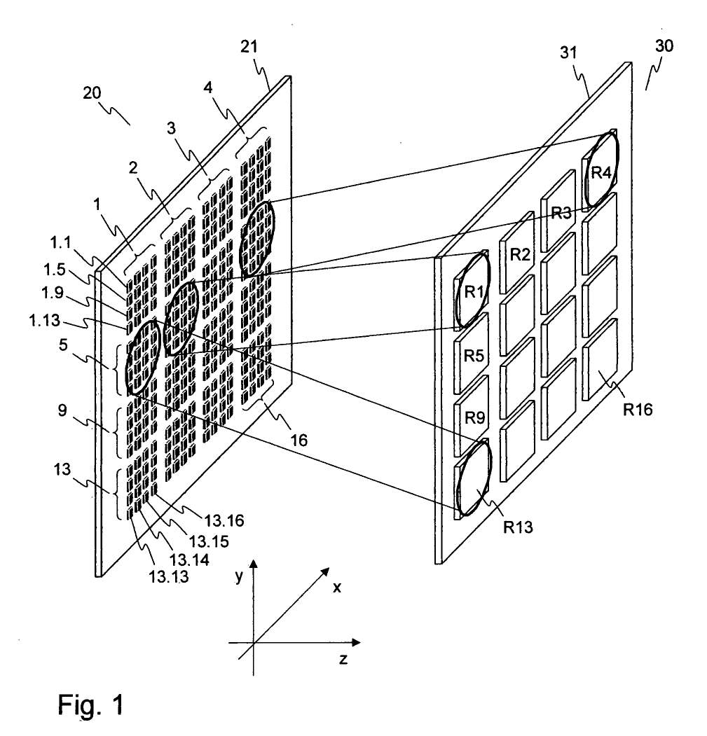

FIG. 1 shows the conception of a crossbar with a transmitter 20 and a receiver 30 for a high speed packet switch. The transmitter 20 comprises a transmitter array mounted on a substrate 21. The transmitter array has 4×4=16 transmitting ports 1 to 16, wherein each of the transmitting ports 1 to 16 has in turn an array of 16 single transmitting antennas. For example, the transmitting port 1 has an array of 4×4 transmitting antennas 1.1 to 1.16, and the transmitting port 13 has also an array of 4×4 transmitting antennas which are indicated with 13.1 to 13.16. The 16 antennas of each transmitting port 1 to 16 work as phased array antennas.

The receiver 30 is arranged opposed to the transmitter 20 and comprises an array of 4×4=16 receiving ports R1 to R16 mounted on a substrate 31. In the embodiment of FIG. 1 each receiving port R1 to R16 has one receiving antenna only.

The embodiment depicted in FIG. 1 forms the crossbar for a high speed packet switch with n=16 inputs and m=16 outputs. However, the invention is not restricted to this embodiment. In general, the crossbar can comprise n inputs and m outputs, wherein n and m can be chosen arbitrarily.

The transmitter 20 and the receiver 30 are facing each other and are located in close proximity, e.g., much less than 1 meter distance. In principle, it is possible to position the receiver 30 in the near field, however, in a mm-wave system the receiving antennas are more likely to be already in the far field. The beam of each individual transmitting port 1 to 16 can be steered by means of phased array antennas, so that each transmitting port 1 to 16 can point to each receiving port R1 to R16. In FIG. 1 for example, the single transmitting antennas 5.1 to 5.16 of transmitting port 5 are driven such that the transmitting beam of transmitting port 5 points to receiving port R13 and thereby forms a first data channel. In contrast, the single transmitting antennas 6.1 to 6.16 of transmitting port 6 are driven such that the transmitting beam of transmitting port 6 points to receiving port R1 and thereby forms a second data channel. Finally, the single transmitting antennas 8.1 to 8.16 of transmitting port 8 are driven such that the transmitting beam of transmitting port 8 points to receiving port R4 and thereby forms a third data channel.

By choosing millimeter wave frequencies, such a high speed switch will fit in a 19 inch rack and will also allow high bit rate to be transmitted on each data channel. If this high speed switch runs e.g. at 60 GHz, it can handle at least 10 Gb/s per data channel and gets by with less space.

A further reduction in size of the transmitter 20 and the receiver 30 can be achieved by increasing the carrier frequency. Increasing the carrier frequency reduces the mechanical size in all three dimensions linearly.

The size of the transmitter 20 and the receiver 30 can also be reduced by filling the space between the transmitter 20 and the receiver 30 with a low loss high dielectric constant material. This results in a size reduction in all three dimensions, width, height and length, of where ∈ᵣ is the relative dielectric constant of the material.

The embodiment shown in FIG. 1 is based on an array of 4×4=16 transmitting ports 1 to 16 with electrical scanning antennas, i.e. each transmitting port consists of an electrical steerable antenna array which is also called hereinafter phased array. Although it is not shown in FIG. 1, it is possible to provide also each of the receiving ports R1 to R16 with an array of electrical scanning antennas. With that, the reception characteristic of each individual receiving port R1 to R16 can be steered by means of phased array antennas, so that each receiving port R1 to R16 can point to each transmitting port 1 to 16. Thereby, crosstalk can be decreased.

The radiation beam of each transmitting port 1 to 16 should fall on one receiving port R1 to R16 only. Using phased array antennas the beams are electrically steerable. Since radiation patterns can be superimposed without any interaction or nonlinear effects, arbitrary numbers of input ports and transmitting beams can operate simultaneous, and a non blocking crossbar architecture will result.

Mechanical moving antennas can be avoided by phased array antennas, effectively eliminating the switching time due to the slow mechanical positioning. A phased array antenna comprises an arrangement of individual identical antennas placed in a one or two dimensional array. In C. A. Balanis, “Antenna Theory, Analysis and Design”, cap. 6 “arrays: linear, planar and circular”, p. 250-300, 2nd ed. ISBN 0-471-59264-4, Wiley, 1997, phased array antennas are described. By varying the phase of the RF (radio frequency) carrier between the individual transmitting antennas, e.g. 5.1-5.16, the resulting beam, which is the superposition of the individual radiating patterns, can be shifted in x and y direction. The phase of an RF signal can be delayed by e.g. an electronic phase shifter circuit. A phase shifter is a standard RF part. Several different implementation methods exist in literature, e.g., W. A. Davis, “Microwave Semiconductor Circuit Design”, ISBN: 0-442-27211-1, Van Nostrand Reinhold, 1984 and 1. Bahl, P. Bharatia, “Microwave Solide State Circuit Design”, ISBN: 0-471-83189-1, John Wiley, 1988. One possible implementation can be a lambda quarter transmission line loaded on each end by a varactor or PIN diode (diode in reverse bias). By varying the bias voltage, a change of the capacitance of the diodes is achieved. This results in a change in phase delay on the line. Such a phase shifter can be varied very rapidly. As a result, the antenna beam pattern of the array antenna can be moved to any desired direction with minimal switching time.

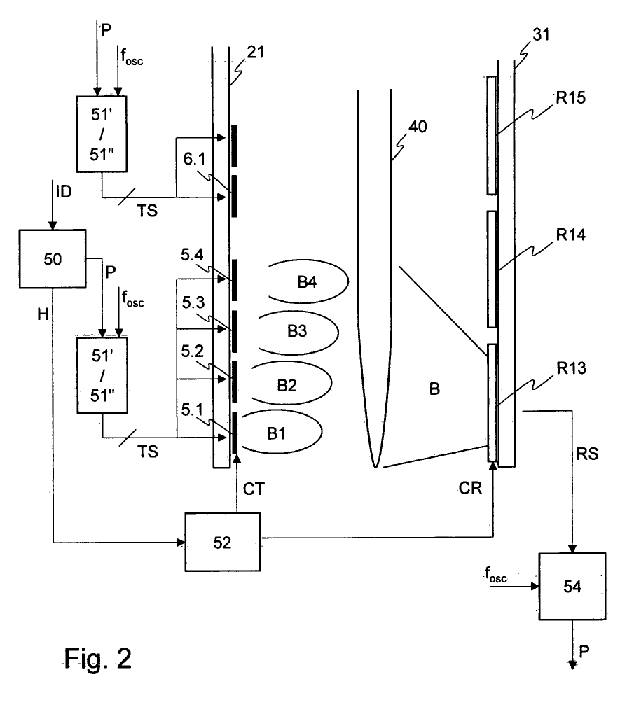

In the following, a more physical implementation is described. FIG. 2 shows a section of the transmitter 20 and the receiver 30 for a high speed packet switch along with electronic control devices 50, 51′/51″, 52 and 54. Input data packets ID are separated by means of a control device 50 into a header H and a payload P. The header H is fed to a further control device 52, which generates thereof a transmitter control signal CT and a receiver control signal CR. The transmitter control signal CT and the receiver control signal CR are used to adjust the transmitting antennas and the receiving antennas respectively. The payload is fed to a transmitting stage 51′ or 51″. On the left hand side four transmitting antennas 5.1, 5.2, 5.3 and 5.4 of the transmitting port 5 are shown. Each transmitting antenna 5.1 to 5.4 produces one of the plane waves B1 to B4. The plane wave, which is the result of a superposition of the individual plane waves B1 to B4, might be tilted.

A dielectric lens 40, which is arranged between the transmitter 20 and the receiver 30, is used to focus the plane waves B1 to B4 onto a single receiving port R13. The dielectric lens 40 is build of a low loss material with a refractive index different from air. At microwave frequencies an additional degree of freedom exists compared to optical wavelengths since materials with a relative dielectric constant ∈ᵣ>1 and ∈ᵣ<1 exist, which creates additional possibilities to implement the lens 40. Depending on the tilt of the incoming plane wave the resulting focused beam B illuminates a different receiving port. The tilt in the incoming plane wave B is realized by phase shifting.

In order to make sure that only one of the receiving ports R1 to R16 is illuminated by a beam the corresponding transmitting port 1 to 16 requires a considerable amount of gain. This can be achieved by a relative large antenna array on the transmitter side 20 and optionally by steerable antenna beams (phased arrays) on the receiver side 30. Furthermore, this can be achieved by using the lens 40 as shown in FIG. 2. As a result, the transmitter-receiver fabric as shown in FIG. 1 can also benefit by a focusing lens 40.

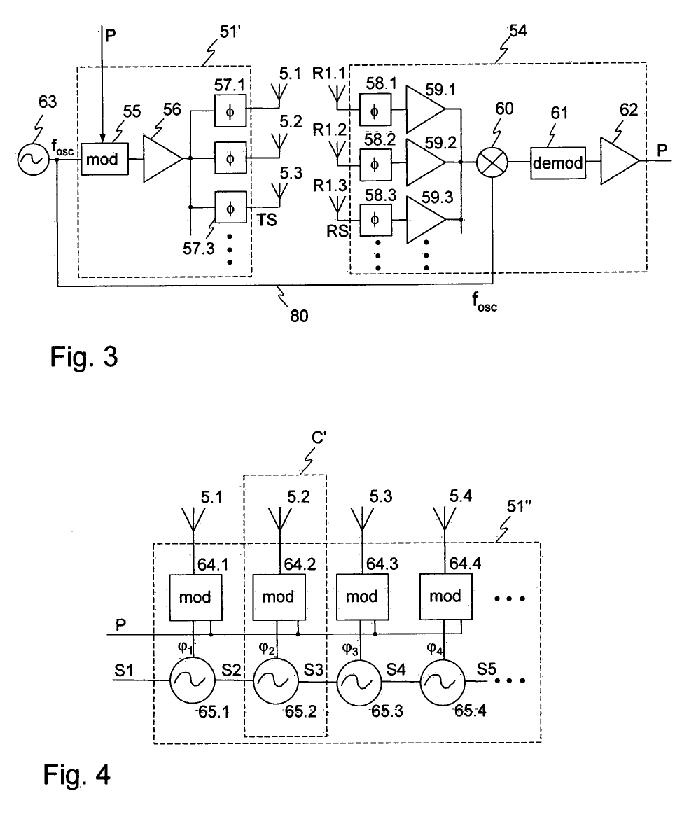

Each transmitting port 1 to 16 of the packet switch, which is hereinafter also called input port, is connected to an individual RF modulator 55 and phase shifters 57.1 to 57.x in order to produce a plane wave (compare FIG. 3), wherein x is the number of individual transmitting antennas. In the embodiment depicted in FIG. 1 x=16. In an other embodiment the individual transmitting antennas can be shared, i.e. the number of transmitting antennas is not linked to the number of input ports of the packet switch. This means, that each transmitting antenna can carry signals from several input ports using combiners. As a result, if three input ports, e.g. 5, 6 and 9, are active, three plane waves will be radiated from the transmitter 20. The plane waves will however, be focused on different receiving ports, e.g. R1, R4 and R13. The received radio signal RS demodulated by means of a receiving stage 54 and the regained payload P is output.

Several implementations of phase shifters are described in literature. One class relies on ferroelectric materials, a second class on switched transmission lines, a third class on capacitively loaded transmission lines and a fourth class on reflection phase shifters. Switching elements are transistors, PIN diodes, varactors or plain diodes. Due to speed consideration Shottkey diodes are most suitable. For this application a fast switching response is helpful.

One possible implementation of the electrical RF part 51′ for one of the transmitting ports 1 to 16 and one RF part 54 for one of the receiving ports R1 to R16 is described next and depicted in FIG. 3. A simple transmitter and receiver architecture is desired. A monolithic microwave integrate circuit (MMIC) would be advantageous. Using deep submicron CMOS processes, this can be even implemented in plain CMOS. A first embodiment of the RF part 51′ for one transmitter port is shown on the left hand side of FIG. 3. A free running and therefore cheap mm-wave oscillator 63, e.g. a gun oscillator is sufficient, which generates the carrier signal with the carrier frequency f_{OSC}. This might however, result in an unstable and temperature dependent carrier frequency f_{OSC}, which should to be considered in the RF part 54 of the receiver. In order for all transmitting ports 1 to 16 to be on equal carrier frequency f_{OSC} one shared source or injection locked oscillator 63 can be used. As modulator 55 an AM (amplitude modulated) or on-off keying modulator can be used. Since the carrier frequency f_{OSC} is chosen in the mm-wave, e.g. 60 GHz, a data rate of 10 Gb/s can be modulated without requiring excessive bandwidth. Since no RF signal is radiated outside the box, the choice of frequency and bandwidth is not governed by any band plan or government regulations. The bandwidth can only be an issue due to limitations in the antenna. An amplifier 56 can be connected between the modulator 55 and the phase shifters 57.1 to 57.x, if required. The phase shifters 57.1 to 57.x are followed by the transmitting antennas, e.g., 5.1 to 5.3. The not stabilized unmodulated carrier frequency f_{OSC} is fed to the RF part 54 of the receiver side of the switch by a cable for down conversion of the carrier frequency f_{OSC}.

The RF part 54 of the receiver side of the switch depends on the switch architecture. If each receiving port R1 to R16 comprises an array of receiving antennas R1.1 to R1.y, each receiving antenna R1.1 to R1.y is connected to an individual phase shifter 58.1 to 58.y as shown on the right hand side of FIG. 3. The number y indicates the number of individual antennas of each receiving port. The received 60 GHz signal RS is mixed down to the base band by an IQ mixer 60, is demodulated by a demodulator 61, and is amplified by an amplifier 62. At the output of the amplifier 62 the payload P of the input data ID is output again.

If each of the receiving ports R1 to R16 comprises only one receiving antenna, as it is shown in FIG. 1, no phase shifters are needed at the receiving ports R1 to R16.

Implementation using coupled oscillators

FIG. 4 shows a second embodiment 51″ of the RF part for one of the transmitting ports 1 to 16. In general, each input port 1 to 16 of the packet switch is connected to such a RF part 51″. In the example of FIG. 4 the transmitting antennas 5.1 to 5.4 of transmitting port 5 are depicted and form a one dimensional array. Each transmitting antenna 5.1 to 5.4 is connected to a one dimensional array of four oscillators 65.1 to 65.4. The oscillators 65.1 to 65.4 are free running VCO (voltage controlled oscillators) connected each via a modulator 64.1 to 64.4 to a single transmitting antenna 5.1 to 5.4. The modulator 64.1 modulates the payload P of the input data signal 11D with a phase φ1, whereas the modulator 64.2 modulates the payload P of the input data signal ID with a phase φ2, and so on. By means of the phase φ the direction of the transmitted plane wave can be steered.

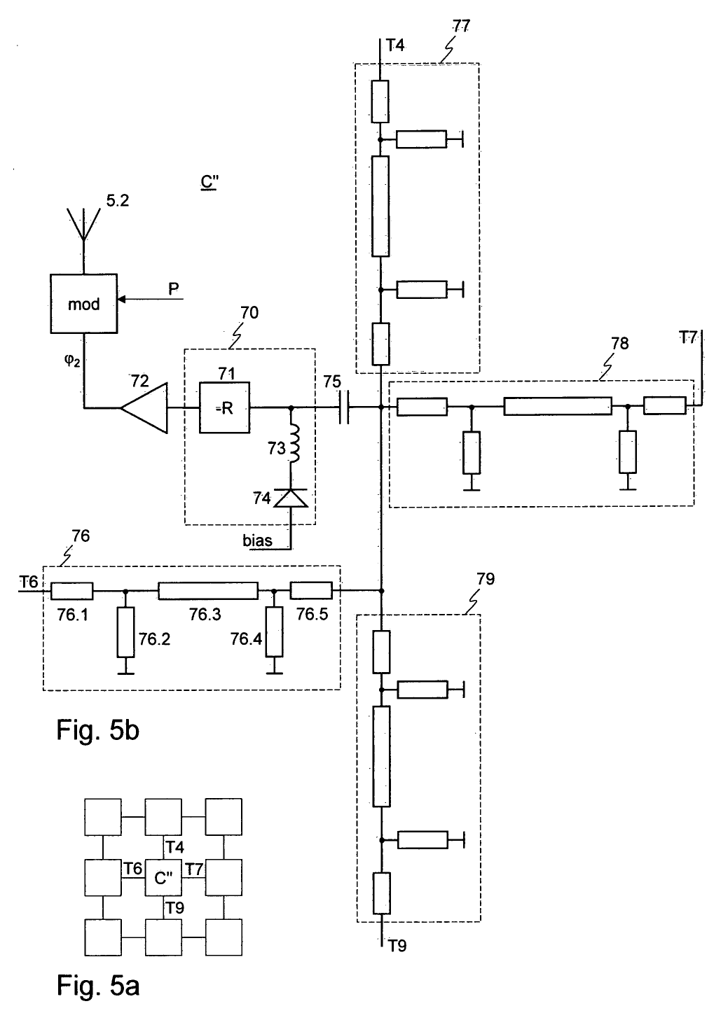

In general, a single transmitting cell C comprises the RF transmitting part for one transmitting antenna and the corresponding transmitting antenna. In FIG. 4 a transmitting cell C′ for a one dimensional transmitting array is used. In contrast thereto, in FIG. 5a a transmitting cell C″ for a two dimensional transmitting array is used. The design of both transmitting cells C′ and C″ is substantially the same. Therefore, in the following the design of the transmitting cell C″ for the two dimensional array will be explained first and the differences to the transmitting cell C′ will be mentioned later on. The transmitting cell C″ is electrically connected to four neighboring transmitting cells of the transmitting array. T4, T6, T7 and T9 indicate the corresponding control signals between the transmitting cell C″ and its neighboring transmitting cells.

FIG. 5b depicts the design of one transmitting cell C″ for a two dimensional transmitting array.

A VCO 70, running at e.g. 60 GHz, comprises a transistor or, in general, a gain element 71, an inductivity or transmission line 73 used as resonator, and a varactor 74 used as tuning element. In addition, the VCO comprises some biasing network. The oscillator frequency f_{OSC} can be controlled via the bias input. In the two dimensional transmitting array the VCO 70 is coupled to its four nearest neighbors by means of four coupling networks 76, 77, 78 and 79. Each of the coupling networks 76, 77, 78 and 79 comprises a transmission line and series resistors. For example, the coupling network 76 comprises a first resistor 76.1, a second resistor 76.2, a transmission line 76.3 and two further resistors 76.4 and 76.5. The resulting transmitting array of FIG. 5a comprising multiple transmitting cells C″ will lock to one common frequency, close to the natural frequency of oscillation, which in the example is 60 GHz. By slightly changing the varactor tuning voltages of the oscillators at the edges of the array, (one side up, other side down) by means of the control signals T4, T6, T7 and T9 the phase of the edge elements, and linearly also the phase of the other elements, is changed. Inside some locking range, the oscillator array remains in lock position. By changing the phase of the outer elements, the radiated beam of the transmitting antenna array is steered. A steering range of +/−30 degree is easily achievable. A typical optical solution can achieve about 1 degree excitation, in one dimension only which limits the number of ports.

Using the above described electrical steerable phased array, phase shifters 57, as used in the embodiment of FIG. 3, are eliminated. The number of control voltages is also drastically reduced. In the embodiment of FIG. 3 a 5×5 array would need 25 control voltages, one for each phase shifter. The electrical steerable array needs four control voltages, two (T6 and T7) for the x-direction and two (T4 and T9) for the y-direction. Compared to an optical implementation, the control voltages are small, which simplifies the electronics. Because of n×n (in the example 25) oscillators the generated power is considerable and no amplifiers are needed. If one oscillator generates 100 SUV, then 25 oscillators would generate 2.5 mW. Since the RF power is not as easily generated at mm-wave frequencies, this is an added benefit. The n×n oscillators can be realized as an MMIC (Microwave Monolithic Integrated Circuit), which would be mounted on the backside of the transmitting port. The modulation of the transmitter can be accomplished by an AM modulation (on/off modulation) of all oscillators or by an FM modulation, where the varactor, already included in all oscillator cells, can be used. Dead time, caused by switching from port to port, is in this implementation very small. Basically, the bias voltage to a varactor should be slightly adjusted. A varactor is essentially a reverse biased PN junction with capacitance much below 1 pF. Switching is also accelerated due to the fact, that only four control voltages per port are required.

In the embodiment, shown in FIG. 3, all ports can be operated on exactly the same carrier frequency f_{OSC}. If in the embodiment, shown in FIGS. 4 and 5, all ports should be operated on exactly the same carrier frequency this would require for e.g. 100 ports 25×100=2500 injection locked oscillators. To reduce the number of injection locked oscillators it is helpful to allow each port to transmit on a slightly different frequency. This has some implementations for the architecture of the receiver 30.

Using a lens 40 as shown in FIG. 2 the receiver would consist of one receiving antenna per receiving port only. Due to the fact that the transmitted power is considerable, in the above example at least 2.5 mW, the transmission loss is minimal and the antenna gain large. Therefore, a simple receiver can be envisioned. A simple receiver comprises a direct demodulation of the transmitted AM modulated 60 GHz signal RS using the above mentioned embodiment with a diode and a capacitor. The diode can be the only needed RF part and can be mounted directly at the receiving antenna. Compared to a conventional microwave link, the propagation loss is minimal, due to the short distance between transmitter and receiver (<1 m). As a result, considerable amount of the generated mm-wave signal (>2.5 mW in the example) can be received by the receiving antenna. The signal at the receiving antenna is orders of magnitude larger compared to a conventional microwave link. The voltage at the demodulation diode is sufficiently large even without an additional amplification which greatly simplifies the receiver. After demodulation a baseband amplifier can be used to restore the data level. Finally a simple FM demodulation can also be envisioned.

The size of a port at 60 GHz is rather small; a 5×5 array is around 2.5 cm by 2.5 cm. The use of a lens 40 can be desirable to further narrow the radiated beam to ensure that only one receiving antenna is illuminated.

The RF part of the transmitter can be implemented with a monolithically integrated VCO 70 with a buffer amplifier 72. The oscillator chip can consist of one packaged chip like PM2503 from Pacific Monolithics and an external resonator 73, 74 consisting of an inductor 73 and a varactor 74. The external resonator 73, 74 allows easy access for injection locking. The oscillator chip PM2503 operates between 2 GHz and 3 GHz. The concept however, works also in the mm-wave range. By adding a buffer amplifier 72 between the oscillator 70 and the transmitting antenna 5.2 the coupling between the individual transmitting antennas is no more relevant for the injection locking of the oscillators. This gives additional freedom for the design of the transmitting antennas and their spacing. The coupling between the oscillators is accomplished using the coupling networks 76 to 79 consisting of a transmission line, e.g. 76.3, with a length of one wavelength. On both ends of the transmission line a termination/attenuation network with resistors, e.g. 76.1, 76.2, 76.4 and 76.5 is added. These resistors lower the quality factor Q of the transmission line and allow a weak and flexible coupling between the oscillators. For a two dimensional array, as shown in FIG. 5a, four nearest neighbors and therefore, four coupling networks would be present. For coupling the voltage controlled oscillator 70 to the coupling networks 76, 77, 78 and 79 a coupling capacitor 75 is provided.

The transmitting cell C′ of FIG. 4 can be implemented in general as shown in FIG. 5b, wherein the control signal S2 corresponds to the control signal T6 and the control signal S3 corresponds to the control signal T7. Because the transmitting cell C′ of FIG. 4 is connected only to two neighboring transmitting cells, the coupling networks 77 and 79 can be omitted in the transmitting cell C′.

Having illustrated and described a preferred embodiment for a novel method and apparatus for, it is noted that variations and modifications in the method and the apparatus can be made without departing from the spirit of the invention or the scope of the appended claims.

1. A transmitter-receiver crossbar for a packet switch, comprising
a transmitter comprising an array of transmitting ports, wherein each transmitting port comprises one or more transmitting antennas to transmit a radio signal; and
a receiver with an array of receiving ports wherein each receiving port comprises one or more receiving antennas to receive the radio signal.

2. The transmitter-receiver crossbar according to claim 1, wherein the receiver is arranged opposite to the transmitter.

3. The transmitter-receiver crossbar according to claim 1, wherein the transmitting antennas of a transmitting port are arranged in lines and columns to form a phased array.

4. The transmitter-receiver crossbar according to claim 3, further comprising a control device to steer the phased array so that the radio signal transmitted by the phased array can be directed to the desired receiving port.

5. The transmitter-receiver crossbar according to claim 1, wherein the receiving antennas of a receiving port are arranged in lines and columns to form a phased array.

6. The transmitter-receiver crossbar according to claim 1, wherein a dielectric material is arranged between the transmitter and the receiver to increase a relative dielectric constant (∈r) in the space between the transmitter and receiver.

7. The transmitter-receiver crossbar according to claim 1, further comprising a lens arranged between the transmitter and the receiver.

8. A packet switch comprising:
a transmitter-receiver-crossbar comprising:
a transmitter comprising an array of transmitting ports, wherein each transmitting port comprises one or more transmitting antennas to transmit a radio signal; and
a receiver with an array of receiving ports wherein each receiving port comprises one or more receiving antennas to receive the radio signal; and
wherein for each transmitting antenna a phase shifter is provided.

9. A packet switch comprising:
a transmitter-receiver crossbar comprising:
a transmitter comprising an array of transmitting ports, wherein each transmitting port-comprises one or more transmitting antennas to transmit a radio signal; and
a receiver with an array of receiving ports wherein each receiving port comprises one or more receiving antennas to receive the radio signal; and
wherein for each transmitting antenna an oscillator is provided, and wherein the oscillators of neighboring transmitting antennas are coupled by means of a coupling network.

10. The packet switch according to claim 8, wherein for each receiving antenna a phase shifter is provided.

11. The packet switch according to claim 9, wherein for each receiving antenna a phase shifter is provided.

12. The packet switch according to claim 8, further comprising a reference oscillator for generating a carrier signal (fosc) connected by means of an electrical line to the transmitter and the receiver.

13. A method for switching data in a switch having an array of transmitting ports, each transmitting port comprising one or more transmitting antennas, and an array of receiving ports, each receiving port comprising one or more receiving antennas, comprising the steps of:
feeding data to one of the transmitting ports;
transmitting the data by means of a radio signal from one of the transmitting ports to a corresponding receiving port; and
extracting the data from the received radio signal at the corresponding receiving port.

14. The method according to claim 13, further comprising the following step before transmitting the data:
modulating the data with a reference frequency (fosc) by means of a modulator; and
shifting the phase (φ) of the modulated data by means of at least one phase shifter.

15. The method according to claim 13, further comprising the following step before transmitting the data:
modulating the data by means of phase shifted modulation signals.
